(19) United States
(12) Patent Application Publication
(10) Pub. No.: US 2021/0404712 A1
(43) Pub. Date: Dec. 30, 2021

(54) EVAPORATOR

(71) Applicant: Wuyi University, Jiangmen City (CN)

(72) Inventor: Min WU, Jiangmen City (CN)

(21) Appl. No.: 17/321,972

(22) Filed: May 17, 2021

(30) Foreign Application Priority Data
Jun. 30, 2020 (CN) 2020106210511

(51) Int. Cl. F25B 9/00; F25B 39/02; F25B 41/40

(52) U.S. Cl. CPC F25B 9/002; F25B 41/40; F25B 39/02

(57) ABSTRACT

Disclosed is a refrigeration system, which may include a generator, a condenser, an evaporator, and an absorber connected in sequence, the condenser being disposed above the evaporator, and the absorber being disposed below the evaporator; the evaporator includes an outer pipe, a hydrogen inlet pipe, and a liquid ammonia pipe; one end of the outer pipe is sealed and the other end thereof is connected to the absorber; the diameter of the end of the outer pipe connected to the absorber is gradually reduced facing a direction of the absorber; the hydrogen inlet pipe is hidden inside the outer pipe; an air outlet end of the hydrogen inlet pipe is disposed at the sealed end of the outer pipe.

### CROSS-REFERENCE TO RELATED APPLICATION

This application claims priority to Chinese patent application No. 202010621051.1, filed Jun. 30, 2020. The content of which is incorporated herein by reference in its entirety.

### TECHNICAL FIELD

The present disclosure relates to the field of refrigeration devices, and more particularly, to a refrigeration system.

### BACKGROUND

Currently, a refrigerant vapor becomes liquid ammonia upon heat release by a condenser, and enters an evaporator; the refrigerant ammonia in the existing evaporator always flows fast from the evaporator, liquid ammonia cannot be fully evaporated or absorb heat, and the refrigeration efficiency of the system is not high.

### SUMMARY

The present disclosure aims at solving at least one of technical problems existing in the prior art. With this regard, the present disclosure provides a refrigeration system capable of improving heat absorption efficiency.

A refrigeration system according to an embodiment in a first aspect of the present disclosure includes a generator, a condenser, an evaporator, and an absorber connected in sequence, the condenser being disposed above the evaporator, and the absorber being disposed below the evaporator;

where the evaporator includes an outer pipe, a hydrogen inlet pipe, and a liquid ammonia pipe; one end of the outer pipe is sealed and the other end thereof is connected to the absorber; the diameter of the end of the outer pipe connected to the absorber is gradually reduced facing a direction of the absorber; the hydrogen inlet pipe is hidden inside the outer pipe; an end of the hydrogen inlet pipe is disposed at the sealed end of the outer pipe; and an end of the liquid ammonia pipe is connected to the condenser and the other end thereof is connected to the outer pipe and connected to the sealed end of the outer pipe.

The refrigeration system according to the embodiment of the present disclosure has at least the following beneficial effects: hydrogen enters the outer pipe through the hydrogen inlet pipe; liquid ammonia enters the outer pipe through the liquid ammonia pipe; when hydrogen is mixed with liquid ammonia and liquid ammonia flows out of an outer sleeve pipe at an end away from the air inlet end of the hydrogen inlet pipe, since the diameter is reduced, a discharging amount of ammonia would be reduced, and a standing time of liquid ammonia in the evaporator would be extended for full evaporation, so as to improve the efficiency of a refrigerating machine.

According to some embodiments of the present disclosure, the end of the outer pipe connected to the absorber is provided with a stair part. Continuously reducing the diameter of an inner cavity which ammonia can pass through when flowing away may effectively slow down the flowing-away of ammonia; in addition, stairs may block ammonia, further slowing down the flowing-away speed of ammonia, and improving the heat exchange efficiency.

According to some embodiments of the present disclosure, the stair part includes several stairs.

According to some embodiments of the present disclosure, the end of the outer pipe connected to the absorber is provided as a slope.

According to some embodiments of the present disclosure, the hydrogen inlet pipe is connected to an upper end of the absorber, and an air outlet end of the outer pipe is connected to a lower end of the absorber. By use of Dalton's Law of Partial Pressure, ammonia having absorbed heat flows downwards to a lower part of the absorber to be mixed with dilute ammonia water and absorbed by the dilute ammonia water.

According to some embodiments of the present disclosure, a lower part of the generator is provided with a heating apparatus. Strong ammonia water in the generator is heated to promote the reaction of the strong ammonia water to form ammonia gas.

According to some embodiments of the present disclosure, the heating apparatus includes an alcohol lamp.

According to some embodiments of the present disclosure, the heating apparatus includes an electric heater.

According to some embodiments of the present disclosure, the condenser is disposed in an air duct. The ammonia gas flows into the condenser to exchange heat with cold air passing through the air duct to generate liquid ammonia.

According to some embodiments of the present disclosure, a distiller is further disposed between the generator and the condenser. Water vapor from the ammonia gas in the generator is absorbed.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the description of embodiments made with reference to the following accompanying drawings, where:

FIG. 1 is a schematic structural diagram of a refrigeration system according to an embodiment of the present disclosure;

FIG. 2 is a schematic mounting structural diagram in an embodiment of an evaporator according to an embodiment of the present disclosure; and

FIG. 3 is a schematic mounting structural diagram in another embodiment of an evaporator according to an embodiment of the present disclosure.

100, generator; 200, condenser; 210, air duct; 300, evaporator; 310, outer pipe; 311, stair part; 312, slope; 320, hydrogen inlet pipe; 330, liquid ammonia pipe; 400, absorber; 500, distiller.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are exemplary, and are only intended to explain the present disclosure and cannot be construed as a limitation to the present disclosure.

In the description of the present disclosure, it should be understood that, for orientation descriptions, orientations or position relationships indicated by terms such as up, down, front, rear, left, and right, are orientations or position relationships shown based on the accompanying drawings, and are used only for ease of describing the present disclosure and simplifying the description, rather than indicating or implying that the apparatus or element should have a particular orientation or be constructed and operated in a particular orientation, and therefore, should not be construed as a limitation on the present disclosure.

In the description of the present disclosure, the meaning of several is one or more, and the meaning of a plurality of is more than two; greater than, less than, exceeding and the like are understood as not including the number itself, and more than, smaller than, within, and the like are understood as including the number itself. The description of first and second are used merely for the purpose of distinguishing the technical features, and shall not be understood as indicating or implying relative importance or implying a quantity of indicated technical features or implying a precedence relationship of the indicated technical features.

In the description of the present disclosure, unless otherwise explicitly defined, words such as setting, mounting, and connecting should be widely understood; a person skilled in the art can reasonably determine the specific meanings of said words in the present disclosure by combining specific contents of the technical solution.

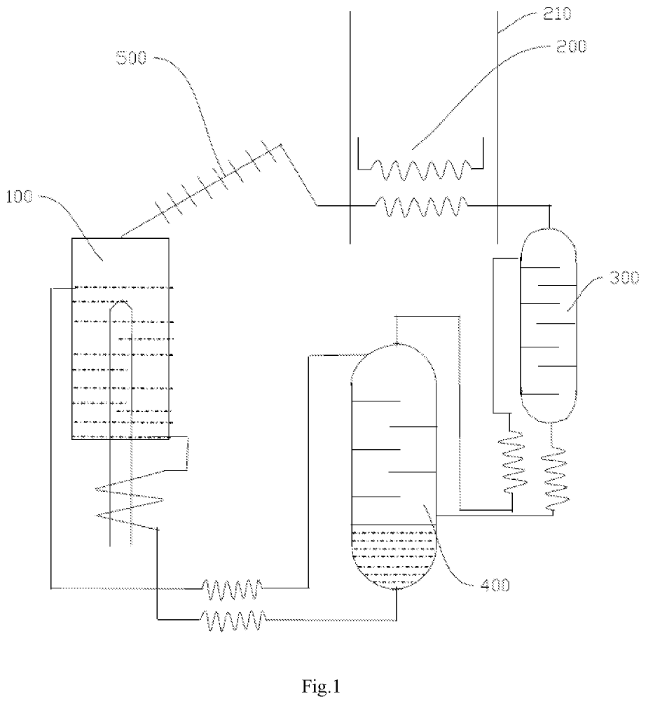

Referring to FIG. 1, a refrigeration system includes a generator 100, a condenser 200, an evaporator 300, and an absorber 400 connected in sequence; the condenser 200 is disposed above the evaporator 300, and the absorber 400 is disposed below the evaporator 300;

where the evaporator 300 includes an outer pipe 310, a hydrogen inlet pipe 320, and a liquid ammonia pipe 330; one end of the outer pipe 310 is sealed and the other end thereof is connected to the absorber 400; the diameter of the end of the outer pipe 310 connected to the absorber 400 is gradually reduced facing a direction of the absorber 400; the hydrogen inlet pipe 320 is hidden inside the outer pipe 310; an end of the hydrogen inlet pipe 320 is disposed at the sealed end of the outer pipe 310; and an end of the liquid ammonia pipe 330 is connected to the condenser 200 and the other end thereof is connected to the outer pipe 310 and connected to the sealed end of the outer pipe 310.

Hydrogen enters the outer pipe 310 through the hydrogen inlet pipe 320; liquid ammonia enters the outer pipe 310 through the liquid ammonia pipe 330; when hydrogen is mixed with liquid ammonia and liquid ammonia flows out of an outer sleeve pipe at an end away from the air inlet end of the hydrogen inlet pipe 320, since the diameter is reduced, a discharging amount of ammonia would be reduced, and a standing time of liquid ammonia in the evaporator 300 would be extended for full evaporation, so as to improve the efficiency of a refrigerating machine.

The circulation process is as follows:

Ammonia circulation: the generator 100 is heated; strong ammonia water in the generator 100 releases ammonia and water vapor, where the ammonia in the condenser 200 is condensed into liquid ammonia; liquid ammonia is encountered with hydrogen in the evaporator 300 and is subjected to pressure reduction, evaporation, heat absorption, and refrigeration, to form ammonia; at this time, ammonia carrying hydrogen flows to the absorber 400 below under the function of gravity; ammonia is absorbed by dilute ammonia water in the absorber 400, and then returns into the generator 100 again, while hydrogen is insoluble in water, so as to implement hydrogen and ammonia separation; and hydrogen enters into the evaporator 300 again along the hydrogen inlet pipe 320.

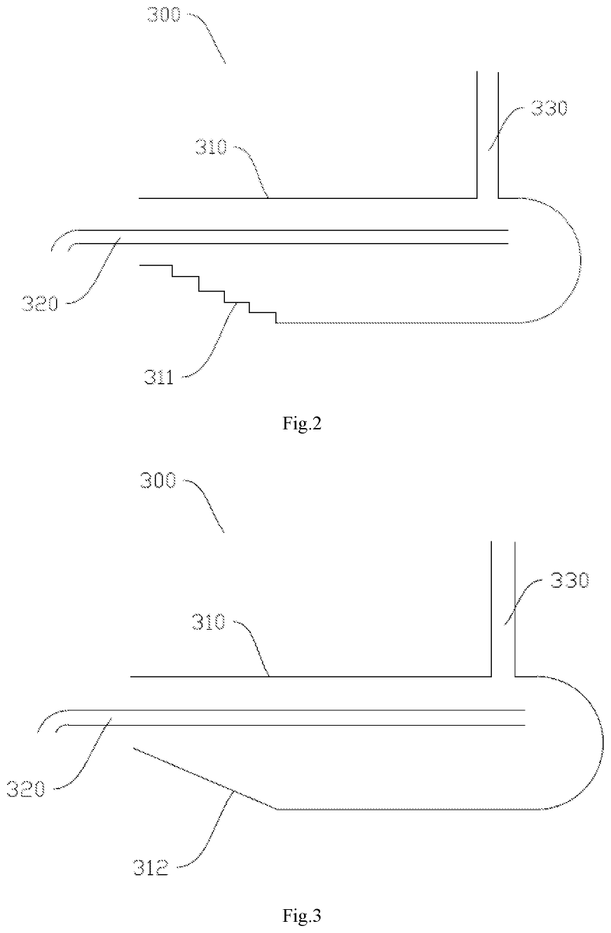

In some embodiments, referring to FIG. 2, the end of the outer pipe 310 connected to the absorber 400 is provided with a stair part 311; and the stair part 311 includes several stairs. Continuously reducing the diameter of an inner cavity when ammonia flows away may effectively slow down the flowing-away of ammonia; in addition, stairs may block ammonia, further slowing down the flowing-away speed of ammonia, and improving the heat exchange efficiency.

In some embodiments, referring to FIG. 3, the end of the outer pipe 310 connected to the absorber 400 is provided as a slope 312.

In some embodiments, the hydrogen inlet pipe 320 is connected to an upper end of the absorber 400, and an air outlet end of the outer pipe 310 is connected to a lower end of the absorber 400. By use of Dalton's Law of Partial Pressure, ammonia having absorbed heat flows downwards to a lower part of the absorber 400 to be mixed with dilute ammonia water and absorbed by the dilute ammonia water.

In some embodiments, a lower part of the generator 100 is provided with a heating apparatus. Strong ammonia water in the generator 100 is heated to promote the reaction of the strong ammonia water to form ammonia gas. The heating apparatus includes devices that can implement heating, for example, an alcohol lamp or an electric heater.

In some embodiments, the condenser 200 is disposed in an air duct 210. The ammonia gas flows into the condenser 200 to exchange heat with cold air passing through the air duct 210 to generate liquid ammonia.

In some embodiments, a distiller 500 is further disposed between the generator 100 and the condenser 200. Water vapor from the ammonia gas in the generator 100 is absorbed.

The embodiments of the present disclosure are explained in detail by combining the accompanying drawings above; however, the present disclosure is not limited to the embodiments above; within the range of knowledge mastered by a person of ordinary skill in the art, various changes may be made without departing from purposes of the present disclosure.

We claim:

1. A refrigeration system, comprising a generator, a condenser, an evaporator, and an absorber connected in sequence, the condenser being disposed above the evaporator, and the absorber being disposed below the evaporator;
wherein the evaporator comprises:
an outer pipe with one end sealed and the other end connected to the absorber, the diameter of the end of the outer pipe connected to the absorber being gradually reduced facing a direction of the absorber;
a hydrogen inlet pipe, hidden inside the outer pipe, an end of the hydrogen inlet pipe being disposed at the sealed end of the outer pipe; and
a liquid ammonia pipe with an end connected to the condenser and the other end connected to the outer pipe and connected to the sealed end of the outer pipe.

2. The refrigeration system of claim 1, wherein the end of the outer pipe connected to the absorber is provided with a stair part.

3. The refrigeration system of claim 1, wherein the end of the outer pipe connected to the absorber is provided as a slope.

4. The refrigeration system of claim 2, wherein the stair part comprises several stairs.

5. The refrigeration system of claim 1, wherein the hydrogen inlet pipe is connected to an upper end of the absorber, and an air outlet end of the outer pipe is connected to a lower end of the absorber.

6. The refrigeration system of claim 1, wherein a lower part of the generator is provided with a heating apparatus.

7. The refrigeration system of claim 6, wherein the heating apparatus comprises an alcohol lamp.

8. The refrigeration system of claim 6, wherein the heating apparatus comprises an electric heater.

9. The refrigeration system of claim 1, wherein the condenser is disposed in an air duct.

10. The refrigeration system of claim 1, wherein a distiller is further disposed between the generator and the condenser.
